(19) United States
(12) Patent Application Publication
(10) Pub. No.: US 2021/0088284 A1
(43) Pub. Date: Mar. 25, 2021

(54) CRYOGENIC COOLING COMPOSITION AND METHOD

(71) Applicant: L' Air Liquide, Société Anonyme pour I'Etude et I'Exploitation des Procédés Georges Claude, Paris (FR)

(72) Inventors: Dominique BELOT, Le Chesnay (FR); Raphael GRANDEAU, Antibes (FR); Carina ZUNDEL, Paris (FR)

(21) Appl. No.: 16/630,003

(22) PCT Filed: Jul. 5, 2018
(86) PCT No.: PCT/FR2018/051692

§ 371 Date: Jan. 10, 2020

(30) Foreign Application Priority Data
Jul. 10, 2017 (FR) 1756516

(51) Int. Cl. F28C 3/18; C09K 5/06; C01B 32/50; C01B 21/00

(52) U.S. Cl. CPC F28C 3/18; C01B 21/00; C01B 32/50; C09K 5/066

(57) ABSTRACT

A cooling composition including a mixture of solid particles of CO₂ and liquid nitrogen, wherein the content of solid particles of CO₂ is between 70 and 85% by weight and the solid particles of CO₂ have a diameter of less than or equal to 50 μm is provided.

### CROSS REFERENCE TO RELATED APPLICATIONS

This application is a 371 of International PCT Application No. PCT/FR2018/051692, filed Jul. 5, 2018, which claims priority to French Patent Application No. 1852158, filed Jul. 10, 2017, the entire contents of which are incorporated herein by reference.

### BACKGROUND

The present invention relates to a cooling composition, and to a cooling process using said cooling composition.

There is a need to produce considerable cooling capacities in all branches of industry, and in parts of the medical fields, for rapidly and deeply cooling reaction media, metal materials, plastics, organic materials, food materials, human tissues, plant tissues, etc.

In addition to refrigeration machines of all types, cryogenic fluids are widely used because they allow the rapid generation of large refrigeration capacities with equipment of simple design.

Two main technologies are used:
immersion of the product to be cooled in a liquid
split jet projected on the surface of the product.

In virtually all industrial cases, the processes are carried out at ambient pressure.

The main media used are liquid nitrogen, liquid argon, and carbon dioxide in liquid or solid form.

Due to being at the liquid-vapour or solid-vapour equilibrium during use, a layer of gas occurs, immediately on contact with the material to be cooled, between the surface of the material to be cooled and the fluid or solid (heating layer). This layer is about 0.1 to 1 millimetre for liquid nitrogen.

Within this heating layer, the conductive heat exchanges are limited by the thermal conductivity of the gas which is lower than that of the liquid and which very greatly reduces the exchange coefficient.

The thermal conductivity of N₂ gas is approximately 17 times less than that of liquid nitrogen, which reflects the fact that the heating layer acts as a heat shield inhibiting heat transfers.

This limits:
the cooling capacities by simple contact
and therefore the use of the media mentioned for fast cooling of solid materials, freezing and preservation of food products, plants, or plant or human tissues.

This heating phenomenon lasts as long as the surface temperature is greater than the Leidenfrost temperature (heating temperature) which is variable according to the surface type and nature.

Below this temperature, the exchange takes place by a normal boiling mode (nucleate boiling and transition boiling) and the heat flow increases considerably although the temperature difference becomes small. An example is presented in FIG. 1.

Indeed, FIG. 1 represents the heat flow expressed in W·m⁻² as a function of the difference in temperature at the liquid/solid interface (surface temperature—the temperature of the liquid) for a brass bar with a diameter of 4 cm and a height of 10 cm and immersed in liquid nitrogen. The initial temperature of the brass is 15° C. Three zones can be distinguished:
a zone A during which the boiling is nucleate boiling;
a zone B during which transition boiling is observed; and
a zone C during which film boiling is observed (heating phenomenon).

In an attempt to circumvent this limitation, several artifices can be implemented:
Cause strong turbulence around the material to be cooled. This substantially increases the heat flow but introduces additional energy expenditure and additional consumption of cold vector.
Subcool, for example, the liquid nitrogen by conducting the process under partial vacuum (by rapid pumping of the gaseous phase). This technique makes it possible to significantly increase the heat flow, but at the expense of a major overconsumption of the cold vector.
Disperse divided materials such as silica in the fluid to promote heat exchange by solid-solid contact.

This significantly increases the heat flow but requires removing the divided materials from the product to be cooled or taking materials compatible with the material to be cooled.
Project liquid jets at high speed to the surface of the product to be cooled in order to reduce, or even break, the heating layer. This makes it possible to greatly increase the heat flow, but at the expense of a significant energy expenditure and overconsumption of the fluid.

From there, a problem which arises is that of providing an improved solution for cooling an element.

### SUMMARY

A solution of the present invention is a cooling composition comprising a mixture of solid particles of CO₂ and liquid nitrogen, in which:
the content of solid particles of CO₂ is between 70 and 85% by weight and
the solid particles of CO₂ have a diameter of less than or equal to 50 μm.

The cooling composition according to the invention is preferably produced by means of a process comprising:
a) a step of forming the particles of CO₂ comprising the expansion of CO₂ gas, preferably in an expansion cone; and
b) a step of mixing the particles of CO₂ and liquid nitrogen.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a graphic representation of the heat flow a function of the difference in temperature at the liquid/solid interface for a brass bar immersed in liquid nitrogen as known in the art.

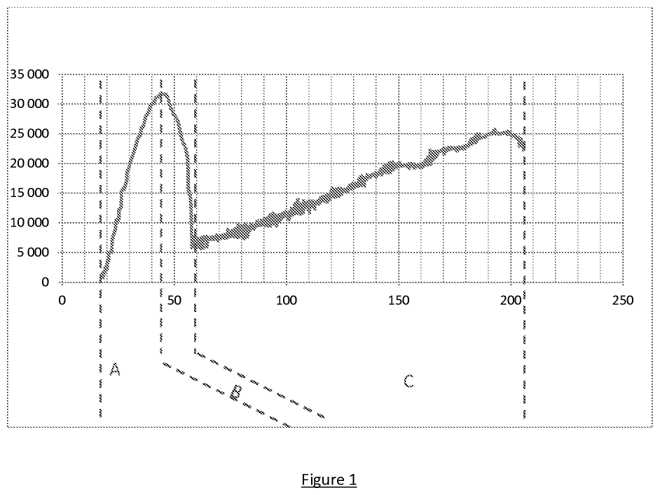

### DETAILED DESCRIPTION OF PREFERRED EMBODIMENTS

A cooling composition comprising a mixture of solid particles of CO₂ and liquid nitrogen is provided, wherein the content of solid particles of CO₂ is between 70 and 85% by weight and the solid particles of CO₂ have a diameter of less than or equal o 50 μm.

The cooling composition is preferably produced by means of a process including a step of forming the particles of CO₂ including the expansion of CO₂ gas, preferably in an expansion cone; and a step of mixing the particles of CO₂ and liquid nitrogen.

These particles either can be dispersed in liquid nitrogen with slight stirring or the liquid nitrogen is poured onto the particles contained in a container. It should be noted that the order of implementation does not affect the size of the CO₂ particles obtained.

In the cooling composition, the liquid nitrogen must completely wet the mass of the particles.

The amount of liquid nitrogen relative to the amount of solid CO₂ should be as close as possible to the amount necessary for:
the liquid nitrogen to wet all the solid CO₂ particles and
there to be a sufficient excess of liquid nitrogen to prevent very fast drying of the solid CO₂ mass (paste) which occurs during the first seconds of quenching of the object to be cooled and which is difficult to compensate for by compensatory injection of liquid nitrogen at the surface.

In this configuration, the solid CO₂ particles cooled at the temperature of the liquid nitrogen are the main vector of the heat exchange participating in the heat exchange by the direct solid/solid contacts and minimize the heating effect. This cooling composition shows a heat exchange capacity that is greatly increased compared to liquid nitrogen under the same conditions.

The cooling composition according to the invention makes it possible to obtain a heat exchange coefficient which is equal to or >230 W·M⁻²·K⁻¹ in the heating zone, that is to say approximately twice that of liquid nitrogen under the same conditions, and which can range up to 210 W·M⁻²·K⁻¹ depending on the conditions in the nucleate boiling zone, that is to say 10 times that of liquid nitrogen under the same conditions.

This cooling composition is sufficiently fluid and manipulable to constitute immersion baths for deep cooling of metals, plastics, food products, plant and human tissues. This involves a very low temperature cooling, known as “deep freezing”. The composition is transferable and “pumpable” by the usual means for the transfer of cryogenic fluids.

A subject of the present invention is also a process for cooling an element to be cooled, using a cooling composition as defined in Claim 1, comprising the following successive steps:
a) stirring the composition at a speed of less than 1 revolution per second,
c) immersing and maintaining the element to be cooled in the composition, with throughout the duration of step c):
   the stirring of step b) is maintained, and
   the proportion of liquid nitrogen in the composition is measured and is kept constant to within plus or minus 5% by the addition of liquid nitrogen.

By virtue of the cooling process according to the invention, cooling at cryogenic temperature of the element to be cooled is made possible.

Preferably, step c) is carried out at a pressure of between 1 bar absolute and 10 bar absolute.

It should be noted that the cooling time depends on the size of the element to be cooled, its shape, the type of material and also its temperature. It can be said that under the same conditions and for one and the same object, the gain in cooling time to reach a target temperature obtained by implementing the process according to the invention is at least 30%.

By way of example, for a bar with a diameter of 40 mm and a height of 100 mm, made of brass (70% Cu/30% Zn), the bar must be immersed for approximately 3 minutes and 30 seconds so that its surface temperature (measured using a Pt100 thermal probe at 3 mm from the edge of the bar) goes down from 13° C. to −196° C.

It should be noted that the stirring of the composition enables the particles to be maintained in homogeneous suspension.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-4. (cancelled)

5. A cooling composition comprising a mixture of solid particles of CO₂ and liquid nitrogen, wherein:
the content of solid particles of CO₂ is between 70 and 85% by weight and
the solid particles of CO₂ have a diameter of less than or equal to 50 μm.

6. A process for producing a cooling composition as defined in claim 5, comprising:
a) forming the solid particles of CO₂ comprising the expansion of CO₂ gas; and
b) mixing the particles of CO₂ and liquid nitrogen.

7. A process for cooling an element to be cooled, using a cooling composition as defined in claim 5, comprising the following successive steps:
a) stirring the composition at a speed of less than 1 revolution per second,
c) immersing and maintaining the element to be cooled in the composition, wherein throughout the duration of step b):
the stirring of step a) is maintained, and
the proportion of liquid nitrogen in the composition is measured and is kept constant to within plus or minus 5% by the addition of liquid nitrogen.

8. The process according to claim 7, wherein step c) is carried out at a pressure of between 1 bar absolute and 10 bar absolute.
